(19) United States
(12) Patent Application Publication
(10) Pub. No.: US 2025/0291092 A1
(43) Pub. Date: Sep. 18, 2025

(54) MICROLENS ARRAY AND PROJECTION DEVICE

(71) Applicant: AGC Inc., Tokyo (JP)

(72) Inventor: Masumi MIYAZAKI, Koriyama-shi (JP)

(73) Assignee: AGC Inc., Tokyo (JP)

(21) Appl. No.: 19/223,408

(22) Filed: May 30, 2025

Related U.S. Application Data
(63) Continuation of application No. PCT/JP2023/043247, filed on Dec. 4, 2023.

(30) Foreign Application Priority Data
Dec. 15, 2022 (JP) 2022-200185

(51) Int. Cl. G02B 3/00; G02B 3/04; G03B 21/20

(52) U.S. Cl. CPC G02B 3/0043; G02B 3/04; G03B 21/208

(57) ABSTRACT

A microlens array includes: a substrate transparent to a used wavelength; and a plurality of aspheric lenses formed on a first face of the substrate, wherein an inflection point density N is 0.50 to 0.80 [/μm] in at least one row of the aspheric lenses in a desired one-dimensional direction in a plane of the first face, and a pitch variation with respect to an average of entire pitches of a region excluding 25% of the aspheric lenses at both ends is less than 7.5%, the aspheric lenses being arranged in a desired one-dimensional direction in the plane of the first face.

### INCORPORATION BY REFERENCE

This application is based upon and claims the benefit of priority from Japanese patent application No. 2022-200185 filed on Dec. 15, 2022, and PCT application No. PCT/JP2023/043247 filed on Dec. 4, 2023, the disclosure of which is incorporated herein in its entirety by reference.

### BACKGROUND

There is known a technique in which a plurality of concave lenses is formed on a surface of a transparent substrate and light is diffused using a phenomenon of refraction of light (see, for example, Japanese Patent No. 6424418 and Japanese Patent No. 6680455). FIGS. 1A and 1B show schematic views of a conventional lens array, where FIG. 1A is a top view and FIG. 1B is a vertical cross-sectional view. In a conventional diffuser plate having an array of concave lenses, the depth of the concave lenses is varied as d1, d2, . . . , and the positions of the center coordinate C of the concave lenses vary in an in-plane direction. In FIG. 1A, as a reference, positions at equal intervals in the X-Y plane are indicated by dotted circles. As compared with the positions at equal intervals, the center coordinate C of the concave lenses is shifted from the center of the positions at equal intervals in both the X direction and the Y direction, and the pitch is varied as P1, P2, . . . in the X-Y plane. That is, in the conventional diffuser plate, the generation of the diffracted light only in a specific direction is suppressed by varying the depth d and the pitch P of the concave lenses.

### SUMMARY

On the other hand, the inventors have found that, in the microlens array, if the pitch of the lenses varies, it is difficult to impart good cutoff characteristics to the profile of the diffusion light.

However, in a regular lens arrangement having a small variation in pitch, there is a concern about generation of diffracted bright spots.

The present invention has been made in view of the above circumstances, and an object of the present invention is to provide a microlens array having good cutoff characteristics and suppressing generation of diffracted bright spots.

A microlens array according to one embodiment of the present invention (hereinafter, also simply referred to as “one embodiment”) includes:
a substrate transparent to a used wavelength; and a plurality of aspheric lenses formed on a first face of the substrate, wherein
an inflection point density N defined by a formula (1) is 0.50 to 0.80 [/μm] in at least one row of an array of the aspheric lenses in a desired one-dimensional direction in a plane of the first face, and
a pitch variation with respect to an average of entire pitches of a region excluding 25% of the aspheric lenses at both ends is less than 7.5%, the aspheric lenses being arranged in a desired one-dimensional direction in the plane of the first face,
the formula (1) being “the inflection point density N=n/X [/μm]”, where
n is a sum of the number of inflection points included in a cross-sectional shape of one row of the aspheric lenses arranged in a desired one-dimensional direction in a region excluding 12.5% of each of the aspheric lenses at both ends, each of the inflection points being defined as a point at which a sign of d″(x) changes when a cross-sectional shape of the aspheric lens is expressed by a function d(x) of a depth d of the aspheric lens and a distance x in a desired one-dimensional direction, d″(x) being a second derivative of d(x), and
X is a sum of distances x [μm] in a desired one-dimensional direction excluding 12.5% of each of the aspheric lenses at both ends of one row of the aspheric lenses arranged in the desired one-dimensional direction.

A microlens array having good cutoff characteristics and suppressing generation of diffracted bright spots is realized.

The above and other objects, features and advantages of the present disclosure will become more fully understood from the detailed description given hereinbelow and the accompanying drawings.

### BRIEF DESCRIPTION OF DRAWINGS

FIGS. 1A and 1B show schematic diagrams of a conventional lens array;

FIGS. 2A and 2B show a schematic cross-sectional view and an image viewed from top of the microlens array according to the one embodiment;

FIG. 3 is a schematic top view of the microlens array according to the one embodiment;

FIG. 4 is a cross-sectional view taken along line X-X′ of FIG. 3;

FIG. 5 shows a view illustrating a lens shape in which an inflection point exists and a view illustrating a lens shape in which an inflection point does not exist;

FIG. 6 is a diagram for explaining a method of calculating an inflection point density N;

FIG. 7 is a diagram for explaining a diffusion profile in which a top region is “flat”;

FIG. 8 is a diagram for explaining a diffusion profile in which a top region is not “flat”;

FIG. 9 is a simulation diagram of a diffusion profile where an in-plane pitch variation of an aspheric lens is changed;

FIG. 10 is a diagram illustrating a change in a cutoff band as a function of the pitch variation;

FIG. 11 is a diagram for explaining how to determine the cutoff band;

FIG. 12 is a diagram for explaining how to determine a slope as a cutoff characteristic;

FIG. 13 is a schematic view of a projection device to which the microlens array of the one embodiment is applied;

FIG. 14 is a diagram showing a diffusion profile in the X direction of Example 1;

FIG. 15 is a diagram showing a diffusion profile in the X direction of Example 2;

FIG. 16 is a diagram showing a diffusion profile in the X direction of Example 3;

FIG. 17 is a diagram showing a diffusion profile in the X direction in Example 4;

FIG. 18 is a diagram showing a diffusion profile in the X direction of Example 6; and

FIG. 19 is a diagram showing a diffusion profile in the X direction in Example 5.

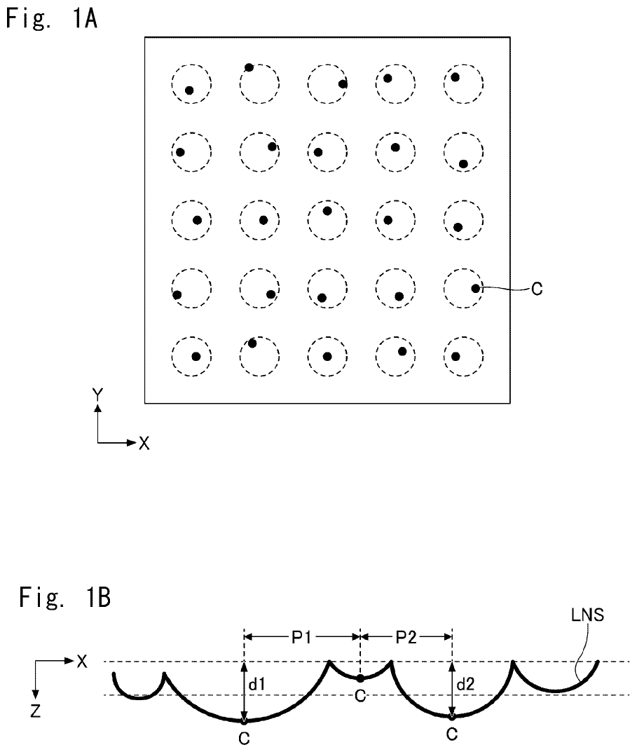

### DETAILED DESCRIPTION

Hereinafter, the present invention will be described in detail, but the present invention is not limited to the following embodiment, and can be arbitrarily modified and implemented without departing from the gist of the present invention. In the present specification, “to” indicating a numerical range is used to mean that preceding and following numerical values are included in the range as a lower limit value and an upper limit value.

In one embodiment, in a microlens array in which a plurality of aspheric lenses is formed on a first face of a substrate transparent to a used wavelength, an inflection point density N defined by the above formula (1) in at least one row of the array of the aspheric lenses is set to a constant range, and a pitch variation of the aspheric lenses is suppressed in a plane of the first face.

Specifically, as will be described later, the inflection point density N is set to 0.50 to 0.80 [/μm], more preferably 0.60 to 0.75 [/μm] in at least one row of the aspheric lenses arranged in a desired one-dimensional direction in the plane of the first face. By setting the inflection point density N within the above range in at least one row of the aspheric lenses, generation of diffracted bright spots is suppressed.

In addition, the pitch variation with respect to the average of the entire pitches of the region excluding 25% of the aspheric lenses at both ends, which lenses are arranged in a desired one-dimensional direction in the plane of the first face, is suppressed to less than 7.5/o, more preferably equal to or smaller than 5.0%. By suppressing the in-plane pitch variation of the aspheric lenses, the cutoff characteristics of the diffusion profile are improved.

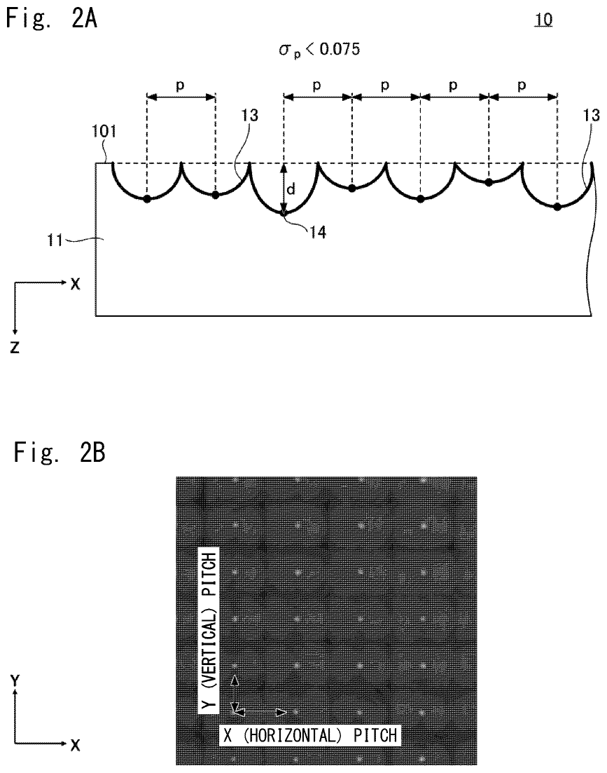

FIGS. 2A and 2B illustrates an example of a microlens array 10 according to the one embodiment. FIG. 2A is a schematic cross-sectional view of the microlens array 10, and FIG. 2B is an image viewed from top.

The microlens array 10 is configured such that a plurality of aspheric lenses 13 are formed on a first face 101 of a substrate 11 transparent to a used wavelength. For example, the plurality of aspheric lenses 13 form rows in the X direction. The rows are arranged in the Y direction. As a result, the plurality of aspheric lenses 13 are provided at grid points of a quadrangular grid and arranged in the quadrangular grid. FIG. 2A schematically illustrates a cross section of one row of the aspheric lenses 13 in a desired one-dimensional direction, the X direction in this example, on the first face 101. In the microlens array 10, the inflection point density N is 0.60 to 0.80 [/μm] in at least one row of the arrangement of the aspheric lenses 13 in the desired one-dimensional direction. By setting the inflection point density N within this range, generation of diffracted bright spots can be suppressed.

As will be described in detail later, the inflection point means a point at which the lens shape of the aspheric lenses 13 changes from an upwardly convex shape to a downwardly convex shape (or from a downwardly convex shape to an upwardly convex shape), and is defined as a point at which the sign of d″(x), which is a second derivative of d(x), changes when the cross-sectional shape of the aspheric lenses 13 is expressed by a function d(x) of a depth d of the aspheric lenses 13 and a desired distance x in the one-dimensional direction. By setting the inflection point density N, which is an index of the number of inflection points present in the at least one row of the array of the aspheric lenses 13 in the desired one-dimensional direction in the microlens array 10, to be within the above range, generation of diffracted bright spots can be suppressed.

On the other hand, a pitch P between centers 14 of the aspheric lenses 13 is substantially constant. “Substantially constant” means that the pitch variation is suppressed to be smaller than a predetermined variation. The pitch variation in the present specification indicates, when an average pitch of a region excluding 25% of entire pitches at both ends in the desired one-dimensional direction is assumed to be 1, an absolute value of a maximum difference that can be taken by a randomly distributed relative pitch ratio in the entire pitches in the region of the lenses in the one-dimensional direction, and is denoted as σ_{P}. In the microlens array 10, when focusing on the lens arrangement in the desired one-dimensional direction, the pitch variation σ_{P} of the aspheric lenses 13 in the region excluding 25% at both ends is suppressed to less than 0.075, that is, the variation with respect to the average pitch is suppressed to less than 7.5%.

In FIG. 2B, a white point at the center of each of the aspheric lenses 13 indicates a lens center. The microlens array 10 includes a quadrangular grid array of the aspheric lenses 13, and has a substantially constant pitch in each of the X direction (horizontal direction of the paper) and the Y direction (vertical direction of the paper). The absolute value of the pitch correlates with a diffusion angle in that direction. In the example of FIG. 2B, an aspect ratio of the pitch in the X direction and the pitch in the Y direction (pitch in the X direction/pitch in the Y direction) is set to be greater than 1, but in a case where a square projection image is formed, the pitch of the aspheric lenses 13 may be designed to set the same value in the X direction and the Y direction. In either case, in the one-dimensional direction such as the X direction and the Y direction, the pitch variation of the aspheric lenses 13 is suppressed to less than 7.5%, more preferably equal to or smaller than 5.0%, and the lens arrangement is substantially regular in the in-plane direction.

Hereinafter, (1) the inflection point density N in the array of the aspheric lenses 13, and (2) regularity of the in-plane arrangement of the first face 101 of the aspheric lenses 13 will be described in detail.

### <Inflection Point Density in Array of Aspheric Lenses>

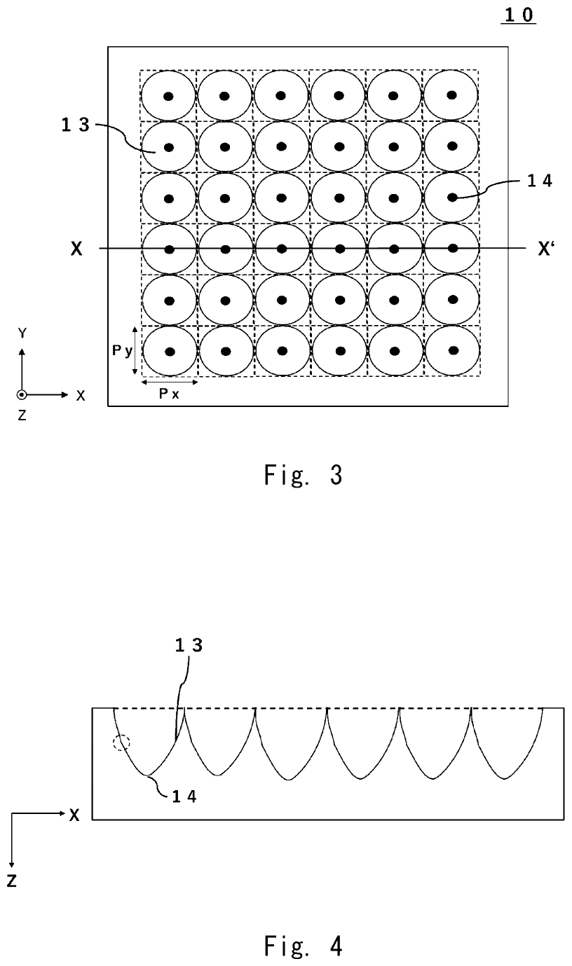

FIG. 3 is a schematic top view of a sample of the microlens array 10 according to the one embodiment, and FIG. 4 is a schematic view of a cross section taken along line X-X′ of FIG. 3. As illustrated in FIG. 3, the plurality of aspheric lenses 13 are regularly arranged in the X-Y plane. In addition, as illustrated in FIG. 4, the aspheric lenses 13 arranged on the microlens array 10 have a local change in the lens shape (see a portion surrounded by a dotted line), and this local change is caused by an inflection point of the aspheric lenses 13. The inflection point means a point at which the lens shape changes from an upwardly convex shape to a downwardly convex shape (or from a downwardly convex shape to an upwardly convex shape).

The present inventor has found that the generation of the diffracted bright spots can be suppressed by setting the number of inflection points of the aspheric lenses 13 within a certain range. Specifically, it has been found that the generation of the diffracted bright spots can be suppressed by setting the inflection point density N defined by the following formula (1) to 0.50 to 0.80 [/μm] in at least one row of the array of the aspheric lenses in the desired one-dimensional direction of the microlens array 10. Hereinafter, the inflection point density N will be described in detail.

$$The inflection point density N = n / X [ / μm ] \qquad ( 1 )$$

where n is a sum of a number of inflection points included in a cross-sectional shape of one row of the aspheric lenses arranged in a desired one-dimensional direction in a region excluding 12.5% of each of the aspheric lenses at both ends, each of the inflection points being defined as a point at which a sign of d″(x) changes when a cross-sectional shape of the aspheric lens is expressed by a function d(x) of a depth d of the aspheric lens and a distance x in a desired one-dimensional direction, d″(x) being a second derivative of d(x), and
X is a sum of distances x [μm] in a desired one-dimensional direction excluding 12.5% of each of the aspheric lenses at both ends of one row of the aspheric lenses arranged in the desired one-dimensional direction.

As shown in the formula (1), the inflection point density N is obtained by dividing a sum n of the number of inflection points in a region where a cross-sectional shape of one row of the aspheric lenses arranged in a desired one-dimensional direction in the microlens array 10 is obtained by excluding 12.5% of each of the aspheric lenses at both ends by a sum of distances x in the desired one-dimensional direction excluding 12.5% of each of the aspheric lenses at both ends, that is, a sum X of the distances x corresponding to a region in which the number of inflection points in each aspheric lens is counted.

Here, each of the inflection points is defined as a point at which a sign of d″(x) changes when a cross-sectional shape of the aspheric lens is expressed by a function d(x) of a depth d of the aspheric lens and a distance x in a desired one-dimensional direction, d″(x) being a second derivative of d(x).

Note that the function d(x) can be obtained, for example, by the following procedures (I) to (III). (I) The three-dimensional shape of each aspheric lens of the microlens array is measured using a laser microscope. The measurement conditions may be, for example, a horizontal resolution of 0.556 μm and a depth resolution of 0.100 μm. (II) The depth d of the aspheric lens in the desired cross-section of the microlens array is measured. (III) The measurement points of the depth d are connected to provide a connection function d(x) is provided. As the laser microscope, for example, VK-X3000 (manufactured by Keyence Corporation) can be used.

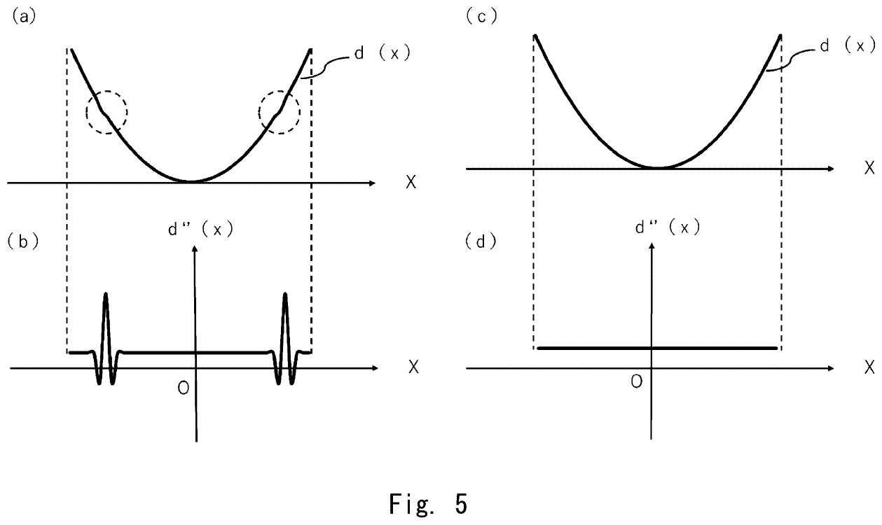

The difference between the shape of the aspheric lens 13 having the inflection point and the shape of the aspheric lens 13 having no inflection point will be described with reference to FIG. 5.

FIG. 5(a) is an example of the cross-sectional shape of the aspheric lens in which the inflection point exists. The cross-sectional shape of the aspheric lens is represented as the function d(x) of the depth d of the aspheric lens and the distance x in the desired one-dimensional direction.

The aspheric lens of FIG. 5(a) has two inflection points. As illustrated in FIG. 5(b), since the sign of d″(x) that is the second derivative of d(x) changes at the inflection point, the number of inflection points (for example, eight in FIG. 5(b)) existing in the aspheric lens can be determined by counting points at which the sign of d″(x) changes.

FIG. 5(c) illustrates an example of the cross-sectional shape of the aspheric lens having no inflection point. As illustrated in FIG. 5(d), in the case of the aspheric lens having no inflection point, a point at which the sign of d″(x) changes does not appear.

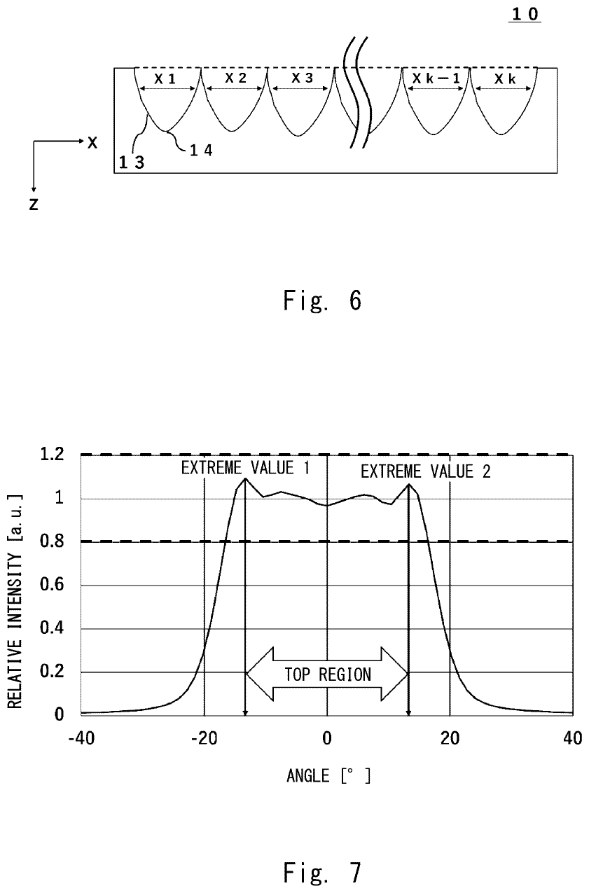

As illustrated in FIG. 6, in the case of calculating the inflection point density N in the cross-sectional shape of a number k of the aspheric lenses 13 arranged in the X direction, the number of inflection points included in each of the aspheric lenses 13 is counted in a region (x1, x2, x3, . . . , xk−1, xk) excluding 12.5% of each of the aspheric lenses 13 at both ends, and a sum of the inflection points is set as N in the formula (1). Thereafter, it is possible to calculate by dividing the calculated N by the sum X (=x1+x2+x3+ . . . +xk−1+xk) of the distances in the desired one-dimensional direction (in FIG. 6, this direction corresponds to the X direction) of the region excluding 12.5% of each of the aspheric lenses at both ends.

In one embodiment, the cross-sectional shape of one row of the aspheric lenses in a desired one-dimensional direction is a shape in a cross section passing through the centers 14 of the aspheric lenses 13 at both ends of the array and orthogonal to the first face 101 of the substrate 11.

By setting the inflection point density N, in the at least one row of the array of the aspheric lenses in the desired one-dimensional direction in the microlens array 10, to be 0.50 to 0.80 [/μm], generation of diffracted bright spots can be suppressed.

The inflection point density N is preferably 0.50 to 0.75 [/μm] and more preferably 0.60 to 0.75 [/μm] from the viewpoint of further suppressing the generation of the diffracted bright spots.

The mechanism in which the inflection point of the aspheric lens in the microlens array contributes to the suppression of the diffracted bright spots is presumed as follows. The diffracted bright spots are generated due to a regular structure. As described above, having an inflection point means that a local change is given to the shape of the aspheric lens. The traveling direction of the incident light of the microlens array changes depending on the shape of the aspheric lens. Therefore, it is considered that the local shape change due to the inflection point gives randomness to the traveling direction of the incident light, and thus functions as a phase difference imparting structure. It is thus considered that as a result, the optical interference of the refracted light is alleviated and diffracted bright spots are suppressed. From this viewpoint, in order to suppress the generation of the diffracted bright spots by the inflection points, the inflection point density N is preferably equal to or greater than 0.50 [/μm].

On the other hand, when the inflection point density N is too large, it is highly probable that an inflection point exists in the vicinity of the center of the aspheric lens. Since the lens is gently inclined in the vicinity of the center of the aspheric lens, the lens shape near the inflection point tends to be identical. It is therefore considered that the lens shape near the inflection point becomes a regular structure, and diffraction may occur. From this viewpoint, in order to suppress the generation of the diffracted bright spots, the inflection point density N is preferably equal to or smaller than 0.80 [/μm] as described above.

In the microlens array 10 according to the one embodiment, by setting the inflection point density N to the above preferable range, the generation of the diffracted bright spots is suppressed, and the diffusion profile in which the intensity distribution of the top is flat can be obtained. In the one embodiment, when a top of the diffusion profile is “flat”, it means that the minimum value of the relative intensity is equal to or greater than 0.800 and the maximum value is equal to or smaller than 1.200 in the top region of the diffusion profile, when the diffusion profile in a desired one-dimensional direction is standardized with the average intensity of the diffusion light in the diffusion angle range from −10 degrees to +10 degrees as 1.

Here, the top region refers to a region in which a range of the diffusion angle is the maximum in a region sandwiched by two diffusion angle points at which the relative intensity takes the extreme value, and the diffusion angle at which the relative intensity takes the extreme value refers to a value of the diffusion angle at which the relative intensity of the diffusion profile switches from increase to decrease or from decrease to increase.

FIG. 7 is an example of a diffusion profile in which the intensity distribution at the top is “flat”. In the diffusion profile of FIG. 7, the minimum value of the relative intensity is equal to or greater than 0.800 and the maximum value is equal to or smaller than 1.200 in the top region sandwiched between the extreme value 1 and the extreme value 2 in which the range of the diffusion angle is the maximum among the two diffusion angle points at which the intensity distribution takes the extreme values, and in the one embodiment, such a diffusion profile is described as the top of the diffusion profile is “flat”.

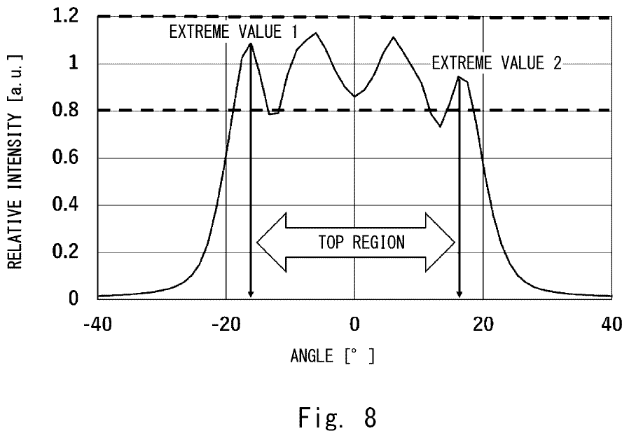

FIG. 8 is an example of a diffusion profile in which the intensity distribution at the top is not “flat”. In the diffusion profile of FIG. 8, the minimum value of the relative intensity is less than 0.800 in the top region sandwiched between the extreme value 1 and the extreme value 2 in which the range of the diffusion angle is the maximum among the two diffusion angle points at which the intensity distribution takes the extreme values.

In the one embodiment, a diffusion profile with a flat top can be obtained by setting the inflection point density N within the preferred range described above.

<Regularity of in-Plane Arrangement of Aspheric Lens>

Next, the regularity of the lens arrangement on the first face 101 of the substrate 11 will be examined. As will be described later, taking a regular arrangement in the two-dimensional plane in which the aspheric lens 13 is arranged is advantageous for cutoff characteristics. The cutoff characteristic of the microlens array 10 refers to steepness of a change in whether light is diffused or blocked in a predetermined direction.

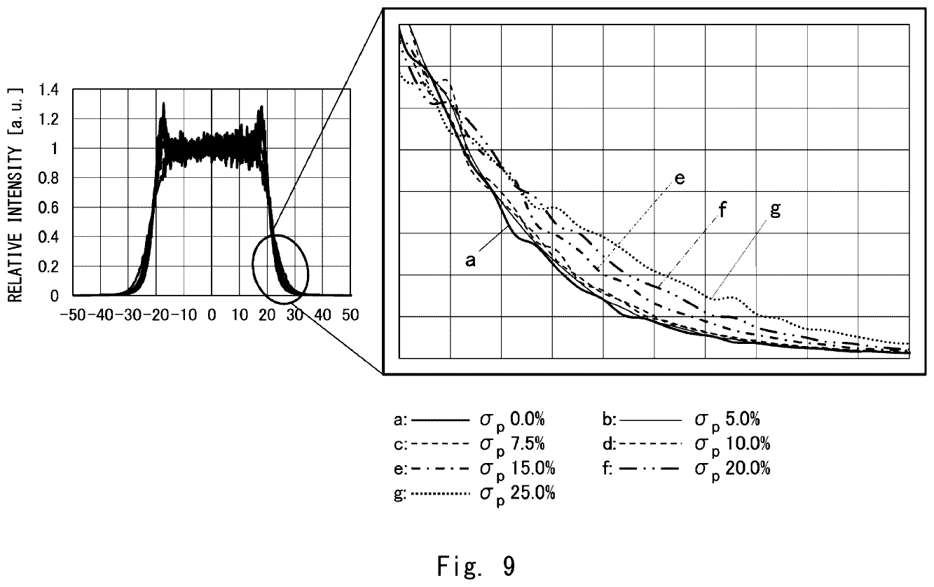

FIG. 9 is a simulation diagram of a diffusion profile where the pitch variation of the aspheric lens 13 is changed. The pitch variation indicates, when an average of all pitches of a region excluding 25% of the aspheric lenses 13 at both ends arranged in the desired one-dimensional direction in the plane of the first face 101 is 1, an absolute value of a maximum difference that can be taken by a randomly distributed relative pitch ratio, and is denoted as σ_{P} (see FIGS. 2A and 2B). In the simulation, the FOV in the X direction is set to 45°, and the diffusion characteristics are calculated by changing the pitch variation in the X direction to 0.0%, 5.0%, 7.5%, 10.0%, 15.0%, 20.0%, and 25.0%.

In the one embodiment, when the term “FOV” of the microlens array 10 is used, the diffusion profile is set to an angular range in which the relative intensity is equal to or greater than 0.5 when the average intensity in the diffusion angle range of −10° to +10° is normalized to 1.

FIG. 9 is an enlarged view of a partial region on the positive side of the diffusion profile. It can be seen that the rising or falling of the diffusion profile becomes more gradual as the in-plane pitch variation increases, and the cutoff characteristics deteriorate.

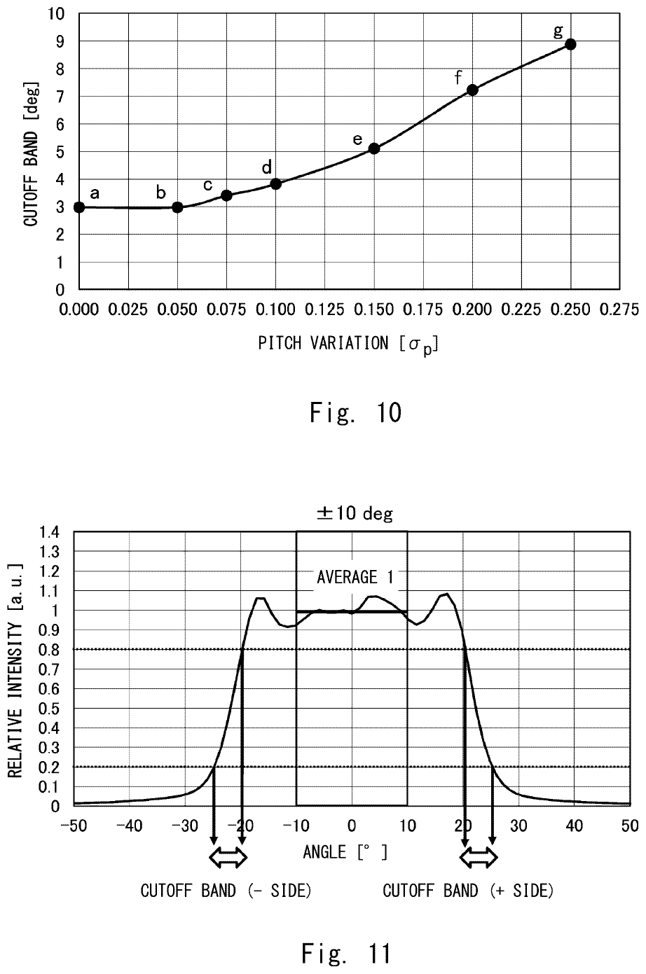

FIG. 10 is a diagram in which the cutoff band is plotted as a function of the pitch variation from the simulation result of FIG. 9. The cutoff band in the one embodiment is an angular width required for the intensity of the diffusion profile to change to a predetermined level. A more accurate definition of the cutoff band will be described with reference to FIG. 11.

FIG. 11 is a diagram for explaining how to determine the cutoff band. The “cutoff band” of the one embodiment is the angular width required for the relative intensity to vary between 0.200 and 0.800. The relative intensity of the diffusion profile is the intensity when the average intensity of the diffusion angle in the range from −10° to +100 is normalized as 1. On each of the negative side and the positive side of the diffusion profile, the angular width when the relative intensity changes from 0.200 to 0.800 or from 0.800 to 0.200 is obtained, and the larger one of the two angle widths is set as the cutoff band.

The smaller the cutoff band, the steeper the rise and fall of the diffusion profile, and the better the cutoff characteristics. As the cutoff band is larger, the rising and falling of the diffusion profile become more gradual, and the cutoff characteristics deteriorate.

Note that, in a case where the cutoff band is calculated on the basis of the actual measurement data of the diffusion profile, it is difficult to accurately calculate the cutoff band as compared with the simulation results as illustrated in FIGS. 9 and 10 from the viewpoint of measurement resolution, and therefore, when evaluating the cutoff characteristics in the actual measurement data of the diffusion profile, evaluation may be performed on the basis of an inclination (slope) using the most approximate value of a predetermined relative intensity and diffusion angle.

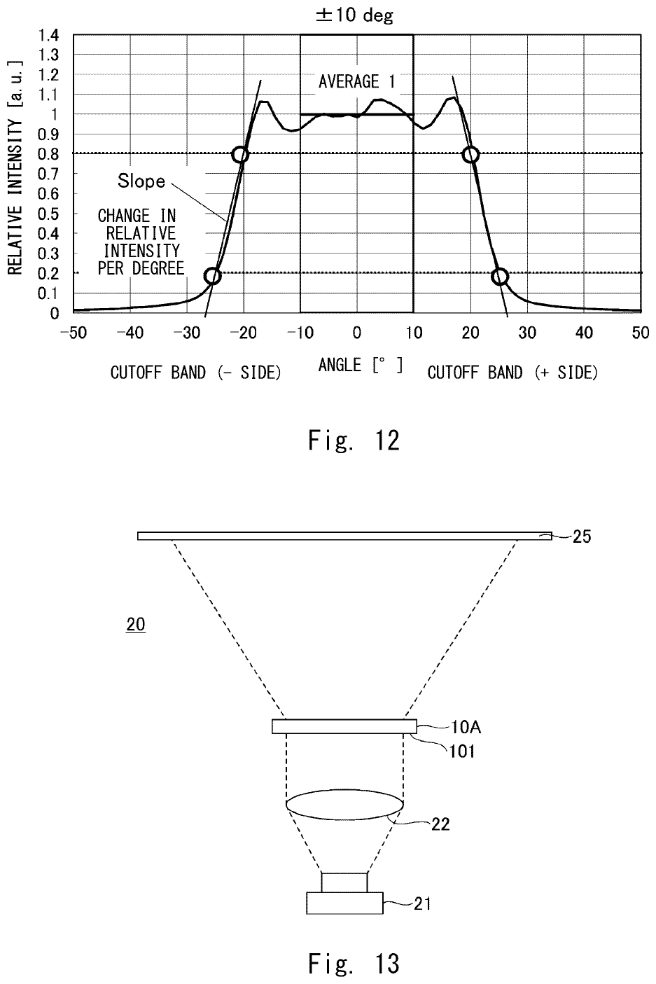

FIG. 12 is a diagram for explaining how to determine the slope. The slope can be calculated by the following procedures (I) to (III). (I) The average intensity in the angular range of the diffusion angle of −10° to +10° is normalized as 1. (II) On the negative side and the positive side of the diffusion profile, the points of the most approximate values with relative intensities of 0.200 and 0.800 are connected, and the inclination of the straight line is obtained. (III) Out of the obtained absolute values of the two inclinations, the smaller one is defined as a slope. From the viewpoint of obtaining good cutoff characteristics, the slope is preferably equal to or greater than 1.0/°, more preferably equal to or greater than 1.1/°, and still more preferably equal to or greater than 1.2/°.

Referring back to FIG. 10, since the cutoff band (°) increases as the pitch variation of the aspheric lens increases, it is desirable to keep the pitch variation small to maintain the cutoff band small. From the viewpoint of reducing the cutoff band, the pitch variation of the aspheric lens 13 is preferably smaller than 0.075 (or 7.5%), and more preferably equal to or smaller than 0.050 (or 5.0%).

In the one embodiment, by setting the pitch variation to the above preferable range, a diffusion profile having good cutoff characteristics can be obtained.

As described above, in the microlens array 10 according to the one embodiment, by setting the inflection point density N and the pitch variation to the preferable ranges described above, it is possible to obtain a diffusion profile having good cutoff characteristics and suppressing the generation of the diffracted bright spots. Hereinafter, a preferable aspect of the microlens array 10 according to the one embodiment will be described from the viewpoint other than the inflection point density N and the pitch variation.

A depth variation of the aspheric lenses 13 in the microlens array 10 is preferably equal to or greater than 1.50 μm, and more preferably equal to or greater than 1.70 μm from the viewpoint of suppressing the generation of the diffracted bright spots. On the other hand, since there is a concern that the refracted light enters the adjacent aspheric lens, the depth variation is preferably equal to or smaller than 6.00 μm, and more preferably equal to or smaller than 4.00 μm. Here, the depth variation is 1σ when depth of the aspheric lenses 13 of the microlens array 10 follow a normal distribution, and is a variation from a median value or an average value (standard deviation).

A variation in a curvature radius R of the aspheric lenses 13 in the microlens array 10 is preferably equal to or greater than 3.50 μm, and more preferably equal to or greater than 3.70 μm from the viewpoint of suppressing the generation of the diffracted bright spots. The variation of the curvature radius R is preferably equal to or smaller than 8.00 μm, and more preferably equal to or smaller than 6.00 μm, because there is a concern that the cutoff performance of the diffusion profile may be deteriorated. Here, the variation in the curvature radius R is 1σ when the curvature radius R of the aspheric lenses 13 of the microlens array 10 follow a normal distribution, and is a variation from a median value or an average value (standard deviation).

As described above, from the viewpoint of suppressing the generation of the diffracted bright spots, variations may be provided in the depth and the curvature radius of the aspheric lenses 13 in the microlens array 10. On the other hand, in the microlens array 10 according to the one embodiment, when the inflection point density N falls within the preferable range described above, it is possible to suppress the diffracted bright spots without setting the variation in the depth and the curvature radius of the aspheric lenses to the preferable range.

The diffusion angle of the microlens array 10 is not particularly limited, and can be appropriately designed according to the purpose, but is preferably equal to or greater than 30°, and more preferably equal to or greater than 40°.

The used wavelength, that is, the light incident on the microlens array 10 is arbitrary as long as the light is transparent to the substrate 11, but is preferably light in at least a part of a wavelength band of 400 to 1000 nm.

### <Application Example of Microlens Array>

FIG. 13 is a schematic view of a projection device 20 to which the microlens array 10 of the one embodiment is applied. The projection device 20 includes a light source 21, a lens 22, and the microlens array 10. The light source 21 is, for example, a light emitting diode (LED). Light emitted from the light source 21 is collimated into parallel light by the lens 22 and enters the microlens array 10. The microlens array 10 is provided on an emission side of the light source 21, and diffuses and projects the emitted light from the light source 21. The microlens array 10 is arranged such that the first face 101 on which the arrangement of the aspheric lenses 13 as concave lenses is formed is on a side of the light source (light incident side). In this example, the microlens array 10 is used as a diffuser plate.

The microlens array 10 diffuses the incident parallel light in the X direction and the Y direction at a predetermined FOV and projects the diffused parallel light on the screen 25. When a laser light source is used instead of the LED as the light source, the lens 22 for collimating may be omitted. In the case of obtaining a color projection image, the microlens array 10 may be arranged for each of a red light source, a green light source, and a blue light source, and emitted light from each microlens array 10 may be synthesized by a prism or the like and projected on the screen 25.

The microlens array 10 of the one embodiment can be applied not only to the projection device but also to an illumination device, an imaging system, and the like. The wavelength selectivity may be provided by tuning the pitch itself while suppressing the pitch variation of the aspheric lens in the plane. In this case, since light having a specific wavelength can be diffused, it is suitable for application to a color projection device.

### <Method of Manufacturing Microlens Array>

One embodiment of a method for manufacturing the microlens array 10 will be described. The method for manufacturing the aspheric lenses 13 in the microlens array 10 is not particularly limited, but for example, the aspheric lenses are formed by performing wet etching on a substrate subjected to a pretreatment. The pretreatment is preferably a method in which a position at which the substrate 11 is present is irradiated with pulsed laser light to modify a part of a region inside the substrate, and a density distribution is provided in the thickness direction at the position irradiated with pulsed laser light.

The shape of the aspheric lenses 13 is determined by a complex factor such as a wavelength, a frequency, power, a pulse width, and a focal position of the laser light when the preprocessing is performed. Hereinafter, preferable conditions of the manufacturing method according to the one embodiment will be described.

In the manufacturing method according to the one embodiment, the wavelength of the laser light is not particularly limited, and examples thereof include 1026 nm, 1064 nm, and 532 nm, and 1064 nm is preferable. The frequency of the laser light is preferably 10 to 50 kHz.

The power of the laser light is preferably equal to or greater than 0.60 W from the viewpoint of imparting sufficient modification for forming lenses on the substrate. On the other hand, from the viewpoint of obtaining a flat diffusion profile, it is preferably equal to or smaller than 1.00 W, and more preferably equal to or smaller than 0.90 W.

The pulse width of the laser light is preferably equal to or smaller than 20 ps, and more preferably equal to or smaller than 15 ps, because rapid cooling after irradiation is necessary. The lower limit of the pulse width is not particularly limited, but may be, for example, equal to or greater than 1 ps.

A focal position of the laser light is preferably −0.250 to +0.100 mm, and more preferably −0.150 to +0.00 mm from the viewpoint of setting the inflection point density N within the preferable range described above. Here, the focal position of the laser light is considered assuming that the first face 101 of the substrate 11 is 0 mm, and the traveling direction of the laser light (the direction from the first face 101 of the substrate 11 to the inside of the substrate 11) is considered as a + direction.

Furthermore, in the manufacturing method according to the one embodiment, it is preferable to apply air at room temperature to the processing point in parallel with the irradiation of the laser light.

This makes it possible to suppress the thermal influence between adjacent processing points and stabilize the modification of the substrate 11.

In the wet etching after the pretreatment, it is preferable to perform the etching so that no flat surface remains between the adjacent aspheric lenses 13. The aspheric lenses 13 adjacent to each other are continuous without a flat surface. This makes it possible to suppress generation of 0th-order light caused by the flat surface.

### Examples

Hereinafter, the present invention will be specifically described with reference to Examples, but the present invention is not limited thereto. Table 1 shows laser light irradiation conditions, the inflection point density N, the minimum and maximum values of the relative intensity in the top region of the diffusion profile, the pitch variation, the slope of the diffusion profile, the depth variation, and the curvature radius variation of each sample of Examples 1 to 6.

Here, the depth variation and the curvature radius variation are 1σ when the depth and the curvature radius follow the normal distribution, and are variations (standard deviations) from the average value.

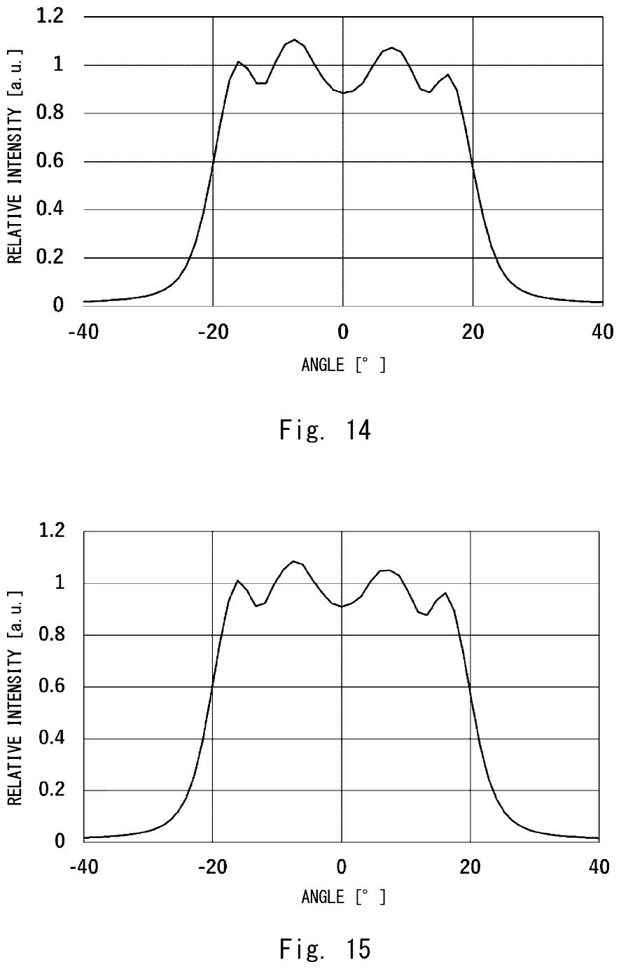

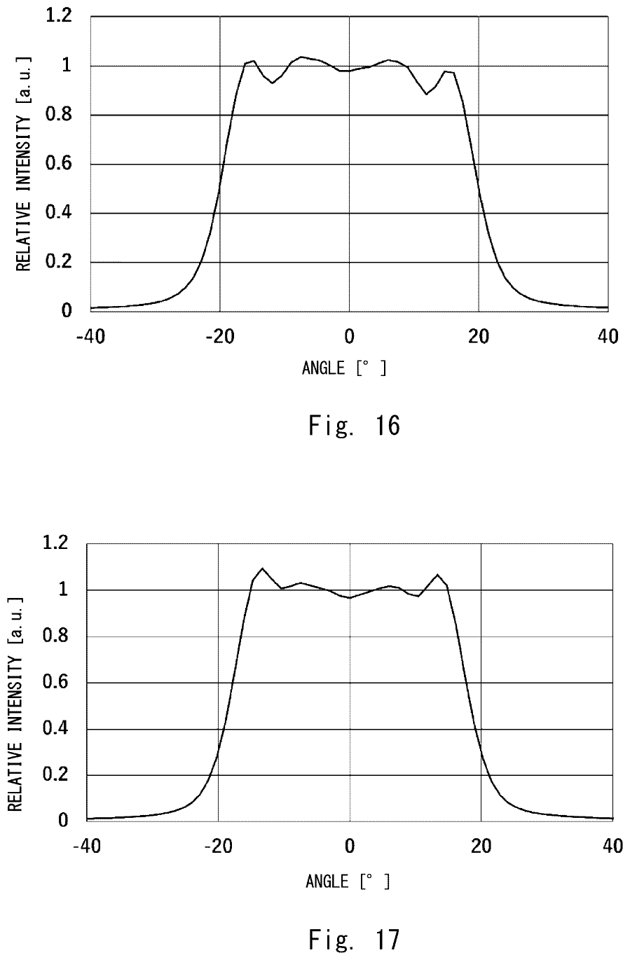

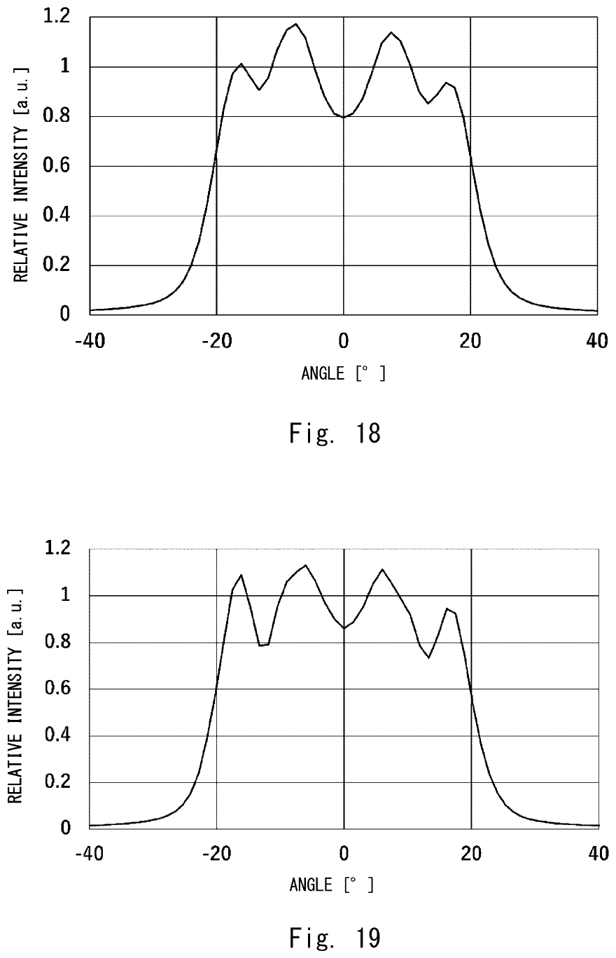

Furthermore, FIGS. 14 to 19 respectively show diffusion profiles in the X direction of the Examples 1 to 6. The diffusion profile is indicated by a relative intensity normalized with an average intensity in a range where the diffusion angle of the diffusion light is −10 degrees to +10 degrees as 1. The wavelength of the incident light in measuring the diffusion profile was 940 nm. Note that the Examples 1 to 4 correspond to practical examples, and the Examples 5 and 6 correspond to comparative examples.

TABLE 1

| | Laser light | | | | | | | | |
|---|---|---|---|---|---|---|---|---|---|
| | irradiation | | | | | | | | |
| | conditions | | Inflection | | | | | | Curvature |
| | | Focal | point | Relative intensity | | Pitch | Slope | Depth | radius |
| | Power | position | density | Minimum | Maximum | variation | (0.8-0.2) | variation | variation |
| | [W] | [mm] | N [/μm] | value | value | [%] | [a.u./deg] | [μm] | [μm] |
| Example 1 | 0.7 | −0.225 | 0.775 | 0.884 | 1.107 | 1.782 | 0.113 | 1.524 | 3.77 |
| Example 2 | 0.7 | −0.195 | 0.582 | 0.878 | 1.086 | 1.741 | 0.11 | 1.74 | 3.956 |
| Example 3 | 0.7 | −0.105 | 0.647 | 0.885 | 1.037 | 2.223 | 0.123 | 2.119 | 3.325 |
| Example 4 | 0.7 | −0.075 | 0.644 | 0.967 | 1.095 | 1.86 | 0.125 | 1.405 | 3.799 |
| Example 5 | 0.7 | −0.255 | 0.863 | 0.733 | 1.13 | 1.517 | 0.13 | 1.715 | 4.023 |
| Example 6 | 1 | −0.315 | 0.883 | 0.796 | 1.172 | 1.016 | 0.116 | 1.144 | 2.83 |

The Examples 1 to 6 are samples of the microlens array in which a total of 100 aspheric lenses are arranged in 10 rows in the X direction and 10 rows in the Y direction, taking a reference pitch in the X direction 40 μm and a reference pitch in the Y direction 40 μm. As shown in Table 1, the pitch variation is different for each sample. As the substrate, a glass substrate (D263) having a thickness of 0.525 mm was used.

In the Examples 1 to 6, an aspheric lens was produced by irradiating a substrate with pulsed laser light, performing pretreatment to modify a part of the inside of the substrate, and then performing wet etching with hydrofluoric acid. The etching time was 35 min.

The irradiation conditions of the laser light at the time of the pretreatment were a wavelength of 1064 nm, a frequency of 20 kHz, and a pulse width of 10 to 15 ps, which were the same conditions through the Examples 1 to 6. On the other hand, the power and focal length of the laser light were different in the Examples 1 to 6, and the conditions shown in Table 1 were used. The processing point was irradiated with laser light while air at room temperature was applied.

In the 10 aspheric lens arrays arranged in the X direction of each of the manufactured samples, one desired row was selected, and the inflection point density N was calculated for 10 aspheric lenses on the lens array on the basis of the above formula (1). Note that the cross-sectional shape of the aspheric lenses at the time of calculating the inflection point density N was a shape in a cross section passing through the centers of the aspheric lenses at both ends of the array and orthogonal to the first face of the substrate.

From the diffusion profiles in Table 1 and FIGS. 14 to 19, it can be seen that in the Examples 1 to 4 having a lens array in which the inflection point density N falls within the preferable range described above, the minimum value of the relative intensity in the top region of the diffusion profile is equal to or greater than 0.800 and the maximum value is equal to or smaller than 1.200, the generation of the diffracted bright spots is suppressed, and a flat diffusion profile can be realized. In addition, in the Examples 3 and 4, by setting the inflection point density N to the above more preferable range, it can be seen that a flatter diffusion profile can be realized as compared with the Examples 1 and 2.

On the other hand, in the Examples 5 and 6 having the lens array in which the inflection point density N is out of the above preferable range, the minimum value of the relative intensity in the top region of the diffusion profile is less than 0.800, and it can be seen that the diffracted bright spot, which is the local light concentration, is generated.

From the above, it can be seen that by setting the inflection point density N within the above preferable range, the generation of diffracted bright spots is suppressed, and a flat diffusion profile can be realized.

Further, from Table 1, it can be seen that in the Examples 1 to 6, the pitch variation falls within the preferable range described above, so that the slope of the diffusion profile is equal to or greater than 0.10/°, and the diffusion profile has good cutoff characteristics.

In the Examples 1 to 6, the slope of the diffusion profile was calculated by the following procedures (I) to (III). The data used for the calculation is shown in Table 2. (I) The average intensity in the angular range of the diffusion angle of −10° to +10° is normalized as 1. (II) On the negative side and the positive side of the diffusion profile, the points of the most approximate values with relative intensities of 0.200 and 0.800 are connected, and the inclination of the straight line is obtained. (III) Out of the obtained absolute values of the two inclinations, the smaller one is defined as a slope.

TABLE 2

| | Example 1 | Example 2 | Example 3 | Example 4 | Example 5 | Example 6 |
|---|---|---|---|---|---|---|
| Most approximate value (1) of | 0.171 | 0.165 | 0.205 | 0.174 | 0.236 | 0.19 |
| relative intensity 0.2 [a.u.] | | | | | | |
| Diffusion angle at most | −24.091 | 24.091 | 22.823 | 21.53 | 22.823 | 24.091 |
| approximate value (1) [deg] | | | | | | |
| Most approximate value (2) of | 0.762 | 0.737 | 0.857 | 0.85 | 0.751 | 0.797 |
| relative intensity 0.8 [a.u.] | | | | | | |
| Diffusion angle at most | −18.877 | 18.877 | 17.517 | 16.136 | 18.877 | 18.877 |
| approximate value (2) [deg] | | | | | | |
| slope (0.8-0.2) [a.u./deg] | 0.113 | 0.11 | 0.123 | 0.125 | 0.13 | 0.116 |

From the above, it can be seen that the microlens array of the Examples 1 to 4 corresponding to the practical examples can realize a microlens array having good cutoff characteristics and suppressing generation of diffracted bright spots by setting the inflection point density N and the pitch variation to the preferable ranges described above.

Although the microlens array and the projection device according to the present invention have been described above, the present invention is not limited to the above embodiments and the like. Various changes, modifications, substitutions, additions, deletions, and combinations are possible within the scope described in the claims. These also naturally belong to the technical scope of the present disclosure.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A microlens array comprising:
a substrate transparent to a used wavelength; and
a plurality of aspheric lenses formed on a first face of the substrate, wherein
an inflection point density N defined by a formula (1) is 0.50 to 0.80 [/μm] in at least one row of an array of the aspheric lenses in a desired one-dimensional direction in a plane of the first face, and
a pitch variation with respect to an average of entire pitches of a region excluding 25% of the aspheric lenses at both ends is less than 7.5%, the aspheric lenses being arranged in a desired one-dimensional direction in the plane of the first face,
the formula (1) being “the inflection point density N=n/X [/μm]”, where
n is a sum of the number of inflection points included in a cross-sectional shape of one row of the aspheric lenses arranged in a desired one-dimensional direction in a region excluding 12.5% of each of the aspheric lenses at both ends, each of the inflection points being defined as a point at which a sign of d″(x) changes when a cross-sectional shape of the aspheric lens is expressed by a function d(x) of a depth d of the aspheric lens and a distance x in a desired one-dimensional direction, d″(x) being a second derivative of d(x), and
X is a sum of distances x [μm] in a desired one-dimensional direction excluding 12.5% of each of the aspheric lenses at both ends of one row of the aspheric lenses arranged in the desired one-dimensional direction.

2. The microlens array according to claim 1, wherein the inflection point density is 0.60 to 0.75 [/μm].

3. The microlens array according to claim 1, wherein the pitch variation is equal to or smaller than 5.0%.

4. The microlens array according to claim 1, wherein when an average intensity in a range where a diffusion angle of diffusion light of the microlens array is from −10 degrees to +10 degrees is normalized as 1 and when a relative intensity is plotted as a function of the diffusion angle, a gradient between points at which the relative intensity is 0.200 and at which the relative intensity is 0.800 is equal to or greater than 0.10.

5. The microlens array according to claim 1, wherein when an average intensity in a range where a diffusion angle of diffusion light of the microlens array is from −10 degrees to +10 degrees is normalized as 1 and when a relative intensity is plotted as a function of the diffusion angle, in a region where a range of the diffusion angle is maximized within a region sandwiched by two points of the diffusion angle at which the relative intensity takes an extreme value, a minimum value of the relative intensity is equal to or greater than 0.800 and a maximum value of the relative intensity is equal to or smaller than 1.200.

6. The microlens array according to claim 1, wherein the aspheric lenses provided on the first face are continuous without a flat surface between the aspheric lenses adjacent to each other.

7. A projection device comprising:
a light source; and
the microlens array according to claim 1 provided on an emission side of the light source,
wherein the microlens array diffuses and projects emitted light from the light source.

8. The projection device according to claim 7, wherein
the aspheric lenses are concave lenses, and
the microlens array is disposed with the first face facing a side of the light source.
